(19) United States
(12) Patent Application Publication
(10) Pub. No.: US 2007/0291721 A1
(43) Pub. Date: Dec. 20, 2007

(54) METHOD FOR OPTIMIZING SYNCHRONIZATION SIGNAL AMONG MULTIPLE HOME AGENTS IN MOBILE INTERNET SERVICE SYSTEM

(75) Inventors: EUN-KYOUNG PAIK, SEOUL (KR); HAN-LIM KIM, SEOUL (KR); SANG-EON KIM, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: KT CORPORATION, SEONGNAM-CITY (KR)

(21) Appl. No.: 11/767,056

(22) Filed: Jun. 22, 2007

Related U.S. Application Data
(63) Continuation of application No. PCT/KR05/04475, filed on Dec. 22, 2005.

(30) Foreign Application Priority Data
Dec. 22, 2004 (KR) 10-2004-0110383

(51) Int. Cl. H04Q 7/24

(52) U.S. Cl. 370/338

(57) ABSTRACT

Provided is a method of optimizing a synchronization signal among home agents in a mobile Internet service system and a computer readable recording medium storing the same. The method includes the steps of: receiving a temporal IP address for a current location and creating terminal active/inactive state information with binding information between the IP address and the temporal IP address; loading the created information into a binding update message, and transmitting the binding update message to one of the multiple home agents; registering new biding information to a binding cache through the home agent that receives the binding update message from the mobile Internet terminal; and determining whether the mobile Internet terminal is in an active state or an inactive state, and synchronizing the registered new binding information with other home agents if the mobile Internet terminal is in the active state.

### CROSS-REFERENCE TO RELATED PATENT APPLICATIONS

This application is a continuation application under 35 U.S.C. § 365(c) of International Application No. PCT/KR2005/004475, filed Dec. 22, 2005 designating the United States. International Application No. PCT/KR2005/004475 was published in English as WO2006/068439 A1 on Jun. 29, 2006. This application further claims the benefit of the earlier filing dates under 35 U.S.C. § 365(b) of Korean Patent Application No. 10-2004-0110383 filed Dec. 22, 2004. This application incorporates herein by reference the International Application No. PCT/KR2005/004475 including the International Publication No. WO2006/068439 A1 and the Korean Patent Application No. 10-2004-0110383 in their entirety.

### BACKGROUND

1. Field

The present disclosure relates to a method of optimizing a synchronization signal among multiple home agents in a mobile internet service system and a computer readable medium storing instructions for performing the same; and more particular, to a method of optimizing a synchronization signal among multiple home agents in a mobile internet service system that optimizes a signal overload by controlling a cycle of synchronizing information among multiple home agents when a registration process and a routing process are managed using the multiple home agents, and a computer-readable recoding medium storing instructions for performing the same.

2. Discussion of the Related Technology

According to the mobile Internet protocol version 4 (Mobile IPv4) or the mobile IPv6 protocol defined in RFC 3344 and RFC 3775 of Internet Engineering Task Force (IETF), the mobile Internet terminal establishes a communication to other terminals by registering information of new location to a home agent when the mobile Internet terminal moves to another location. Then, the home agent forwards the communication packets to the mobile Internet terminal according to the current location.

If a mobile Internet terminal updates the information about new location to one home agent when the multiple home agents are managed to record information about locations of the mobile Internet terminals, the home agent receiving the update information transmits a synchronization signal and information thereof to other home agents to synchronize the new location information of the mobile Internet terminal with other home agents.

Due to the scheme of updating the new location information and synchronizing with others, the operational load of transmitting the synchronization signal and the information thereof significantly increases if there are many home agents in the mobile Internet service system and the cycle of updating and synchronizing the location information is very short.

The foregoing discussion in this section is to provide general background information, and does not constitute an admission of prior art.

### SUMMARY

One aspect of the present invention provides a method of optimizing a synchronization signal among home agents in a mobile Internet service system by determining whether a synchronization signal and information are transmitted or not according to an active state or an inactive state of a mobile Internet terminal, and a computer readable recording medium storing instructions for performing the same.

In accordance with one aspect of the present invention, there is provided a method for optimizing synchronization among multiple home agents in a mobile Internet service system, the method comprising the steps of: receiving a temporal Internet protocol (IP) address for a current location of a mobile Internet terminal and creating terminal active/inactive state information with binding information between a home IP address and the temporal IP address while managing the mobile Internet service system according to a mobile Internet protocol; loading the created information into a binding update message, and transmitting the binding update message to one of the multiple home agents; registering new biding information to a binding cache through the home agent that receives the binding update message from the mobile Internet terminal; and determining whether the mobile Internet terminal is in an active state or an inactive state, and synchronizing the registered new binding information with other home agents if the mobile Internet terminal is in the active state.

The method may further include the step of reducing a cycle of synchronizing the registered new binding information if the mobile Internet terminal is in the inactive state by not synchronizing the registered new binding information with other home agent.

In accordance with another aspect of the present invention, there is provided a computer readable recording medium storing instructions to perform a method for optimizing a synchronization signal among multiple home agents in a mobile Internet service system, the method including the steps of: receiving a temporal Internet protocol (IP) address for a current location of a mobile Internet terminal and creating terminal active/inactive state information with binding information between a home IP address and the temporal IP address while managing the mobile Internet service system according to a mobile Internet protocol; loading the created information into a binding update message, and transmitting the binding update message to one of the multiple home agents; registering new biding information to a binding cache through the home agent that receives the binding update message from the mobile Internet terminal; and determining whether the mobile Internet terminal is in an active state or an inactive state, and synchronizing the registered new binding information with other home agents if the mobile Internet terminal is in the active state.

The method of the computer readable recording medium may further include the step of reducing a cycle of synchronizing the registered new binding information if the mobile Internet terminal is in the inactive state by not synchronizing the registered new binding information with other home agent.

A method of optimizing a synchronization signal among home agents according to an aspect of the present invention optimizes a use of resources such as power and bandwidth which are wasted for transmitting by optimizing a load of transmitting a synchronization signal and information thereof among multiple home agents managed according to a mobile IPv4/IPv6.

### BRIEF DESCRIPTION OF THE DRAWINGS

The above and other aspects and features of the present invention will become apparent from the following description of embodiments given in conjunction with the accompanying drawings, in which:

FIG. 1 is a block diagram of a mobile Internet service system with an Internet terminal in accordance with an embodiment of the present invention;

FIG. 2 shows a format of a typical binding update message of a mobile Internet terminal;

FIG. 3 is a table showing fields of a typical binding update message of a mobile Internet terminal;

FIG. 4 shows a format of an expanded binding update message for a mobile Internet terminal in accordance with an embodiment of the present invention;

FIG. 5 is a table showing a field of an expanded binding update message of a mobile Internet terminal in accordance with an embodiment of the present invention; and

FIG. 6 is a flowchart illustrating a method of optimizing synchronization signal among multiple home agents in a mobile Internet service system in accordance with an embodiment of the present invention.

### DETAILED DESCRIPTION OF EMBODIMENTS

Other aspects of the invention will become apparent from the following description of the embodiments with reference to the accompanying drawings, which is set forth hereinafter.

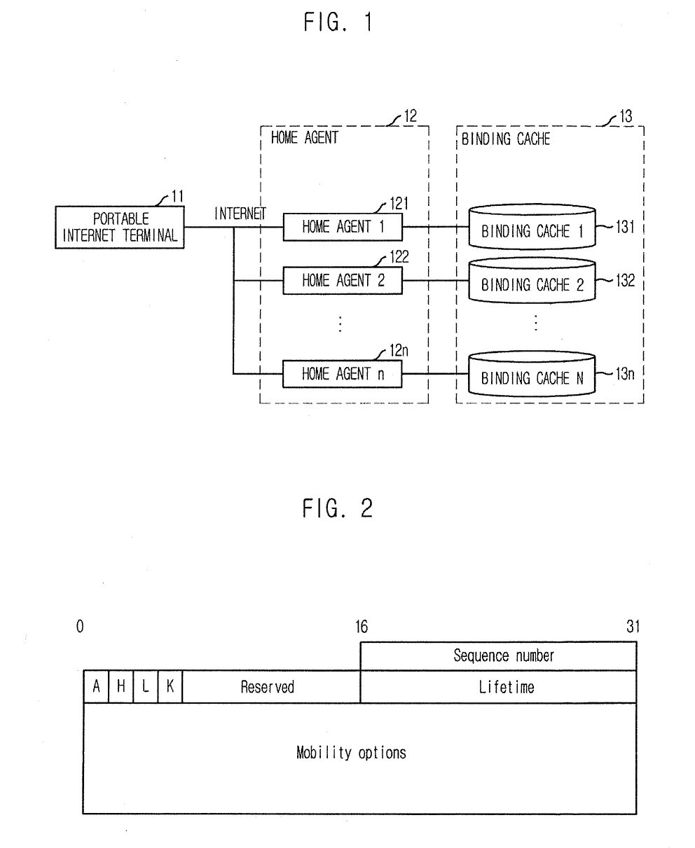

FIG. 1 is a block diagram of a mobile Internet service system with an Internet terminal in accordance with an embodiment of the present invention. In FIG. 1, a numeral reference 11 denotes a mobile Internet terminal, a numeral reference 12 denotes a home agent unit and a numeral reference 13 is a binding cache. As shown, there is a plurality of home agents 121 to 12N in the mobile Internet service system and each of them includes one of binding caches 131 to 13N.

If a home agent 121 receives a binding update message from the mobile Internet terminal 11, the home agent 121 synchronizes binding information of other home agents 122 to 12N based on the received binding update message when a plurality of home agents 121 to 12N is managed according to the mobile IPv4 or the mobile IPv6 for the mobile Internet service, as shown in FIG. 1. In an embodiment of the present invention, a signal overload is optimized by controlling a cycle of a synchronization signal according to an active state of the mobile Internet terminal 11 when the binding information of the multiple home agents 122 to 12N.

In other words, FIG. 1 shows a structure of binding and updating location information of the mobile Internet terminal 11. As shown, the mobile Internet terminal 11 receives a temporal Internet protocol (IP) address for a current location when the mobile Internet terminal 11 moves to other location and establishes a binding between a home IP address and a temporal IP address. Then, the mobile Internet terminal 11 loads the binding information into a binding update message with terminal active/inactive state information and transmits the binding update message to corresponding one of home agents 121 to 12N. When the home agent 121 receives the binding update message from the mobile Internet terminal 11, the home agent 121 registers the new binding information to the binding cache 131 according to the binding update message. Then, the home agent 121 synchronizes the binding information of other home agents 122 to 12N based on the new binding information.

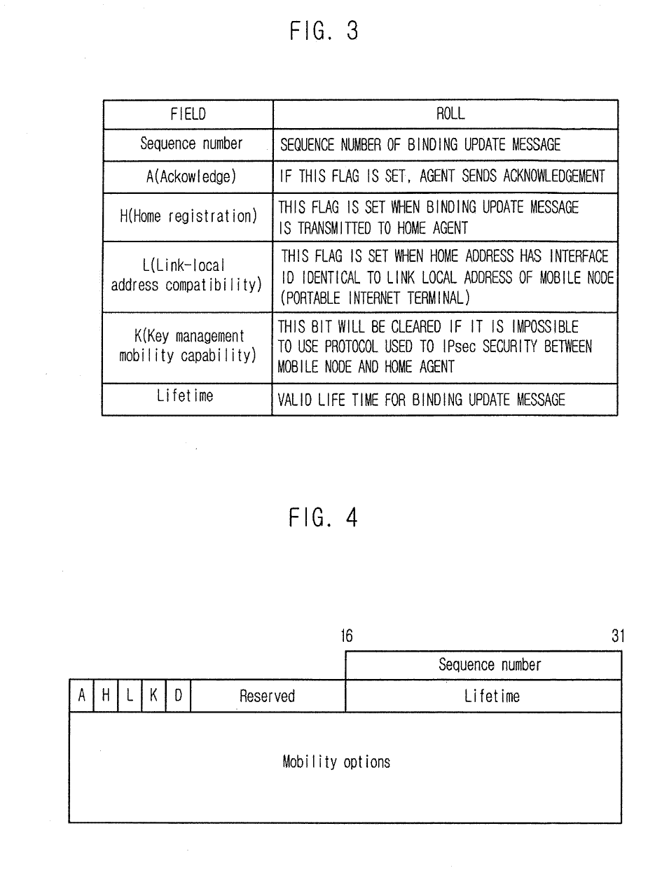

FIG. 2 shows a format of a typical binding update message of a mobile Internet terminal, and FIG. 3 is a table showing fields of a typical binding update message of a mobile Internet terminal.

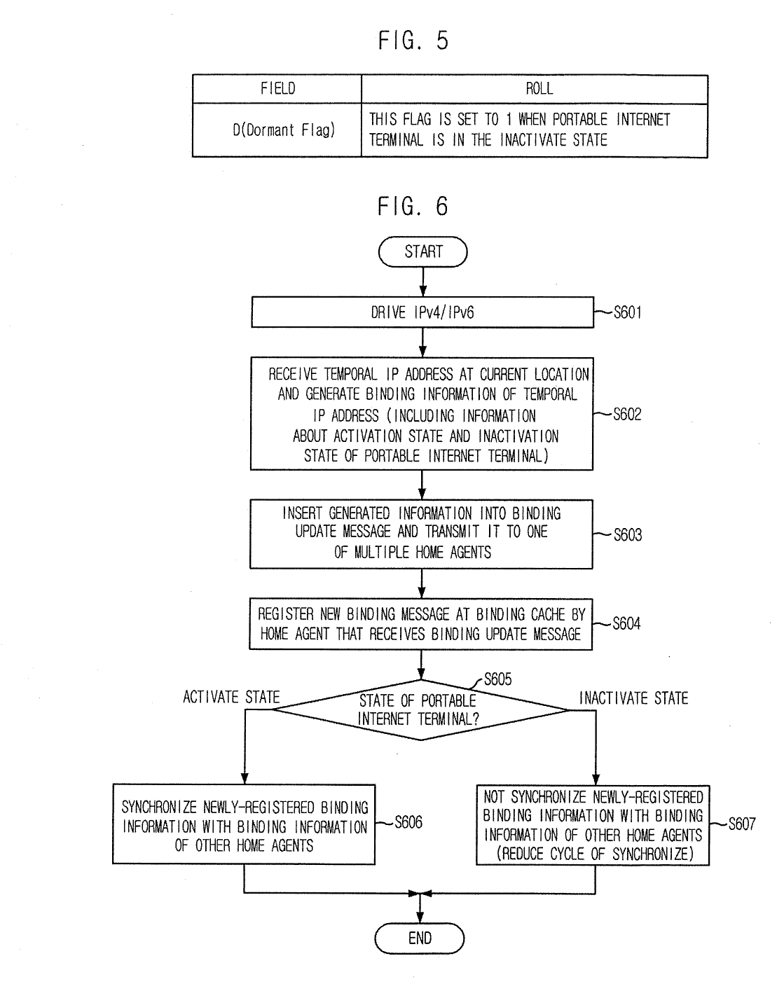

FIG. 4 shows a format of an expanded binding update message for a mobile Internet terminal in accordance with an embodiment of the present invention. That is, FIG. 4 shows the binding update message expanded to notice a state of a mobile Internet terminal to a home agent, for example, an inactive state and an active state. FIG. 5 is a table showing a field of an expanded binding update message of a mobile Internet terminal in accordance with an embodiment of the present invention.

As shown in FIGS. 4 and 5, if a dormant flag (D) field, which is a state notice bit D, is set to ‘0’, it denotes that the mobile Internet terminal is in the active state. Therefore, if the home agent 121 receives the binding update message with the D field set to ‘0’, the home agent 121 transmits the synchronization signal and the information thereof to other home agents.

On the contrary, if the dormant flag field is set to ‘1’, it denotes than the mobile Internet terminal is in the inactive state. Accordingly, a cycle of synchronization is reduced. That is, the mobile Internet terminal transmits the binding update message with the D field set to ‘1’ when the mobile Internet terminal is in the inactive state. If the home agent receives the binding update message with the D field set to ‘1’, the home agent discards to transmit the synchronization signal to other home agents. Therefore, the cycle of synchronizing the binding information is reduced.

As described above, the method of optimizing a synchronization signal among home agents according to the present embodiment effectives providing services by applying a signal protocol managing method of the mobile IPv4/IPv6 for mobile Internet service.

Hereinafter, the method of optimizing a synchronization signal among multiple home agents in a mobile Internet service system in accordance with an embodiment of the present invention will be described with reference to FIG. 6.

FIG. 6 is a flowchart illustrating a method of optimizing a synchronization signal among multiple agents in a mobile Internet service system in accordance with an embodiment of the present invention.

As shown in FIG. 6, a mobile Internet terminal additionally creates information of active/inactive sate bit at step S602 when the mobile Internet terminal receives a temporal IP address for a current location and generates binding information between the home IP address and the temporal IP address according to the mobile IPv4 or the mobile IPv6 at step S601.

Then, the mobile Internet terminal loads the created binding information to a binding update message by inserting the active/inactive state information of the mobile Internet terminal, and transmits the binding update message to one of multiple home agents at step S603.

Then, if a home agent receives the binding update message from the mobile Internet terminal, the home agent registers new binding information to a binding cache according to the new binding information at step s604.

After registering, the home agent analyzes the state of the mobile Internet terminal according to the state notice bit included in the binding update message at step S605.

If the state of the mobile Internet terminal is in the active state after determining at step S605, the home agent synchronizes the newly-register binding information with other home agent at step S606.

If the state of the mobile Internet terminal is in the inactive state after determining at step S605, the cycle of synchronization is reduced by not synchronizing the binding information with other home agents.

The above-described method according to embodiments of the present invention can be embodied as a program and stored on a computer readable recording medium. The computer readable recording medium is any data storage device that can store data that can be thereafter read by the computer system. The computer readable recording medium includes a read-only memory (ROM), a random-access memory (RAM), a CD-ROM, a floppy disk, a hard disk and an optical magnetic disk.

While embodiments of the present invention has been described, it will be apparent to those skilled in the art that various changes and modifications may be made without departing from the scope of the invention as defined in the following claims.

What is claimed is:

1. A method for optimizing a synchronization signal among multiple home agents in a mobile Internet service system, the method comprising:
receiving a temporal Internet protocol (IP) address for a current location of a mobile Internet terminal and creating terminal active/inactive state information with binding information between a home IP address and the temporal IP address while managing the mobile Internet service system according to a mobile Internet protocol;
loading the created information into a binding update message, and transmitting the binding update message to one of the multiple home agents;
registering new biding information to a binding cache through the home agent that receives the binding update message from the mobile Internet terminal; and
determining whether the mobile Internet terminal is in an active state or an inactive state, and synchronizing the registered new binding information with other home agents if the mobile Internet terminal is in the active state.

2. The method as recited in claim 1, further comprising reducing a cycle of synchronizing the registered new binding information if the mobile Internet terminal is in the inactive state by not synchronizing the registered new binding information with other home agent.

3. The method as recited in claim 1, wherein the binding update message includes a state information bit that denotes the active state or the inactive state of the mobile Internet terminal.

4. The method as recited in claim 1, wherein the home agent receives the active state information through the mobile Internet terminal and uses the received active state information as a variable to calculate a cycle of synchronization.

5. A computer readable recording medium storing instructions to perform a method for optimizing a synchronization signal among multiple home agents in a mobile Internet service system, the method comprising:
receiving a temporal Internet protocol (IP) address for a current location of a mobile Internet terminal and creating terminal active/inactive state information with binding information between a home IP address and the temporal IP address while managing the mobile Internet service system according to a mobile Internet protocol;
loading the created information into a binding update message, and transmitting the binding update message to one of the multiple home agents;
registering new biding information to a binding cache through the home agent that receives the binding update message from the mobile Internet terminal; and
determining whether the mobile Internet terminal is in an active state or an inactive state, and synchronizing the registered new binding information with other home agents if the mobile Internet terminal is in the active state.

6. The computer readable recording medium as recited in claim 5, wherein the method further comprises reducing a cycle of synchronizing the registered new binding information if the mobile Internet terminal is in the inactive state by not synchronizing the registered new binding information with other home agent.
